(19) United States
(12) Patent Application Publication
(10) Pub. No.: US 2007/0066295 A1
(43) Pub. Date: Mar. 22, 2007

(54) Method and network for downloading data to mobile devices

(76) Inventors: Martin Wennberg, Bromma (SE); Britt-Mari Svensson, Sollentuna (SE); Tommy Thorstensson, Bromma (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/596,018

(22) PCT Filed: Dec. 29, 2004
(86) PCT No.: PCT/SE04/02049

§ 371 Date: May 25, 2006

(30) Foreign Application Priority Data
Dec. 30, 2003 (SE) 0303606-8

(51) Int. Cl. H04M 3/00

(52) U.S. Cl. 455/419; 455/517

(57) ABSTRACT

The method is for downloading data to mobile devices belonging to a mobile telecommunications network. When downloading of update information to one or more mobile devices is initiated in some way, a message with update information to be sent to the mobile devices is formed on the basis of the stored information. The formed information message is then downloaded to the mobile devices. The network is for downloading data to mobile devices that have mobile devices and a mobile telecommunications network to which the mobile devices belong. The network also has a repository containing information of terminal capabilities and/or subscriber information of the mobile devices in the network,

### TECHNICAL FIELD

The invention is concerned with a method and network for downloading data to mobile devices belonging to a mobile telecommunications network.

### TECHNICAL BACKGROUND

Even if mobile terminals basically are devices for sending voice and data through radio signals, they are available in a wide variety of standards and technologies. How fast the data can be sent depends on how quickly the terminals can send and receive signals on a particular network.

In US, mobile terminals send signals at 800 MHz and/or 1900 MHz, other countries allow mobile frequencies at 900 MHz and 1800 MHz. While some mobile terminals are single band, i.e. they work at only one of these frequencies, others, known as dualband or triband, work at two or three frequencies.

The main differences between analog and digital technologies is in the form that the signals take. While analog phones send speech messages directly as voice waves, digital phones convert voice sounds into computer codes, which later are changed back into voice sounds for someone to hear. Some mobile terminals, known as dualmode or trimode, can handle two or three different mobile technologies.

Basically, CDMA (Code Division Multiple Access) and TDMA (Time Division Multiple access), are the two main digital technologies for mobile terminals, GSM and iDEN (Integrated Dispatch Enhanced Network) being important forms of TDMA.

GSM (Global System for Mobile Communication) is the world's most common digital technology for mobile phones, especially in Europe, while iDEN is mainly used in Americas. GSM and iDEN are forms of TDMA that can handle data.

CDPD (Cellular Digital Packet Data) is something that can be added to TDMA phone to allow data calls, so that computer related applications, like e-mail, file transfers and Internet browsing can be performed. GPRS (General packet Radio Service) is a packet switching technology for GSM networks. It is an advanced data transmission without the need of a continuous connection to internet and can send and receive data at speeds up to 115 kbps, typical speeds being, however, 28,8 bps-44 kbps, depending on the mobile phone being used, the network implementation and the network capacity.

Different networks use different technologies, and different technologies are capable of different speeds. It all depends on what equipment a networks owns and what technology that equipment uses.

Java technology consists of both a programming language and a software platform. The core benefit of the Java platform is that it can run on top of several different operating systems, hiding the complexity of the device from the applications and application developers. Interoperability provided by the Java platform is also very valuable for phone users. Applications created with standard Java APIs should run in all compatible devices, no matter who has manufactured them.

Besides different technologies, mobile applications work with such different characteristics as form factor or viewing area sizes, browser capabilities, languages supported, available input methods, text coverage, graphics support etc (display performance), expandability options and slots (peripherals and accessories), push technology support, ruggedness, information storage capability, adding new data to the devices (Memory), device performance calculations and logic (Processor speed) etc.

Also networks have their own standards in terms of connectivity and functionality aspects. These include gateways, towers and access links that are dependent on an organization's use of network protocols, application logic and device access. The characteristics for wireless networks are defined in terms of support to open Internet standards and protocols, extent of wireless networks coverage, cost factors, uniform/spotty coverage, data transmission speed, security concerns, time taken to service requests, authentication capabilities, etc.

Different characteristics to be considered for downloading mobile applications are therefore, standards, technologies, bandwidth constraints, mobile application characteristics, network functionality etc.

Today it is impossible to download correct data and with the right means to a certain terminal without having the subscriber to explicitly defining model and capabilities since different terminals use different technologies and have different subscriber profiles. While the mobile market is progressing at a rapid stride, the major components—devices, wireless networks and applications—are constantly evolving at varying speeds.

The wireless market is developing with a myriad of devices using different technologies and user preferences to deploy updates to mobile applications. There is a need for methods which take different device configurations and technologies into consideration and communicate accordingly.

### SUMMARY OF THE INVENTION

The method of the invention for downloading data to mobile devices belonging to a mobile telecommunications network is characterized by that information of device capabilities and/or subscriber information of the mobile devices in the network are stored. When downloading of update information to one or more mobile devices is initiated in some way, a message with update information to be sent to said one or more mobile devices is formed on the basis of said stored information. The formed information message is then downloaded to said one or more mobile devices.

The network of the invention for downloading data to mobile devices, comprising mobile devices and a mobile telecommunications network to which the mobile devices belong, is characterized in that it further comprises a repository containing information of terminal capabilities and/or subscriber information of the mobile devices in the network.

The content of the message to be downloaded is based on e.g. the capabilities of the mobile device(s) such as the download protocol used (e.g. SynchML, OTAP, Openwave), if it supports Java, WAP or GPRS, screen capabilities (size, colors, if it can present images), if it supports Short Message Service (SMS), Enhanced Message Service (EMS), Multimedia Message Service (MMS), Bluetooth, which bandwidths (900, 1800, 1900 etc.) if e-mails can be received, ring signals (polyphonic or monophonic) and/or it can be based on the subscription of the subscriber(s) of the mobile device(s) such as parameters for said subscription. The content to be downloaded can also be based on the location of the mobile device(s).

Downloading of update information is e.g. initiated on the basis of a specific parameter value to be downloaded, such as the change of the IP address of a certain proxy. Thus, given information is downloaded to those devices already having a value on the parameter to be updated. If e.g. the subscribers of a given operator are divided in three groups to use three equal proxies, and the oldest one starts being. overloaded, the operator might buy a new proxy. Then a part of the users now using the overloaded proxy are lead to use the new one.

The initiation can also be caused by the availability of a new version of software to be downloaded to all subscribers' devices (or phones) having a certain model containing an older version of the telephone's software, and also having defined that they want software updates (in their subscription).

The invention covers the means for downloading the correct data and choosing the correct download method, based on the capabilities of the handset to provision, the capabilities of the subscription used, the configuration of the handset (based on what have been downloaded before) and the location of the handset.

The core for all the functions is to have a repository containing a) information of what handset model to provision and optionally b) the capabilities of the phones to be provisioned c) data downloaded to a specific handset.

Based on the capabilities of a certain handset the appropriate configuration parameter values are chosen, and the preferred, and available to this model, download protocol is used.

Based on what subscription a subscriber has different data or methods could be chosen for provisioning a handset. For example a GPRS enable handset (with a GPRS subscription) should have the GPRS parameters updated and should be configured to use GPRS as bearer for WAP. The same handset model without a GPRS subscription should use a circuit switch data channel as a data bearer, and the GPRS settings need not to be updated.

Based on where a subscriber is located different data could be chosen for provisioning a handset. For example a handset turned on in France could be configured to use a different Proxy than it would if turned on in Australia for data traffic, e.g. to minimize the traffic in the mobile network and preferably use the backbone IP networks instead.

Based on a specific parameter value downloaded to one or more handsets, that (or some other) parameter should be updated with a new value. For example when the IP address of a certain proxy is changed, the new IP address should be downloaded to all handsets configured to use this certain proxy.

When a new version of a handset software or a mobile service is available from what is (downloaded to) on a handset, the new version could be automatically downloaded, or an indication sent to the phone that the new version is available, all based on subscriber preferences.

A great flexibility in updating handsets with the correct information can be achieved without requiring the provisioning to be end-user initiated, or even without requiring any information from an end-user regarding handset or handset capabilities.

In the following the invention is presented by means of some examples by referring to flow schemes. The intention is not to restrict the invention to the details of these examples. Especially it is pointed out that the invention is meant to cover the whole device, including both the terminal and the SIM.

### FIGURES

FIG. 1 shows an environmental view of a network of the invention, wherein the invention can be implemented.

FIG. 2 presents an example of an embodiment of the invention, wherein the downloading of update information to one or more mobile devices is initiated by a terminal switch

FIG. 3 presents an example of an embodiment of the invention, wherein downloading of update information to one or more mobile devices is operator initiated

FIG. 4 presents an example of an embodiment of the invention, wherein downloading of update information to one or more mobile devices is initiated by a terminal switch

FIG. 5 presents an example of an embodiment of the invention, wherein downloading of update information to one or more mobile devices is user initiated

FIG. 6 presents an example of an embodiment of the invention, wherein downloading of update information to one or more mobile devices is initiated by a new location of the terminal

### DETAILED DESCRIPTION

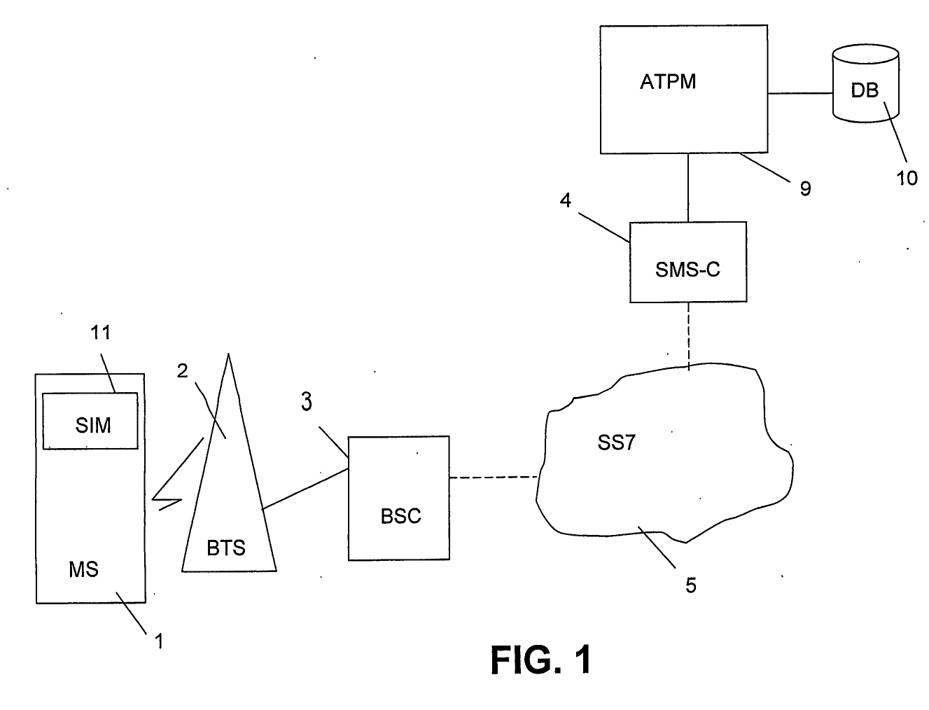

The GSM network has different parts. The Mobile Station (MS) with reference number 1 is carried by the subscriber. The Base Station Subsystem (BSS) controls the radio link with the Mobile Station. A cell is formed by the coverage area of a Base Transceiver Station (BTS) having reference number 2 in FIG. 1, which serves the MS 1 in its coverage area. Several BTS stations together are controlled by one Base Station Controller (BSC) having reference number 3 in the figure. The BTS 2 and BSC 3 together form the Base Station Subsystem (BSS). The Mobile Station and the Base Station Subsystem communicate across the air interface through a radio link.

The Network Subsystem, the main part of which is the Mobile services Switching Center (MSC) (not shown) performs the switching of calls between the mobile and other fixed or mobile network users, as well as management of mobile services, such as authentication. The Operations and Maintenance center (not shown) oversees the proper operation and setup of the network.

The communication from BSC 3 further is based on signaling system no. 7 (SS7) protocol, which is indicated with reference number 5 in the figure and constitutes the wireless network signaling infrastructure in GSM. SS7 is a global standard for telecommunications defined by the International Telecommunication Union (ITU) Telecommunication Standardization Sector (ITU-T). The SS7 standard defines the procedures and protocol by which the network elements exchange information over a digital signaling network to effect secure worldwide telecommunications.

The Short Message Service Center (SMSC) with reference number 4 in FIG. 1 enables subscribers to send and receive messages and is interfaced with the Mobile Switching centers (MSCs) over an SS7 link.

All the above functions are parts of the GSM standard. When implemented in GSM, the invention introduces some further functions in the network.

Inventive functions in FIG. 1 are the Adaptive Terminal Provisioning Manager (ATPM). It is connected to a repository, which is a database (DB) containing information of terminal capabilities and/or subscriber information of the mobile terminals in the network, such as information about standards, technologies, bandwidth constraints, mobile application characteristics, network functionality etc. The subscriber information might include information about which terminal a subscriber has, what data is downloaded on different terminals, and information about subscription and possibly what information a subscriber wants to have about new applications, updates, etc. Thus, the repository might contain one or more of the following basic information: terminal frequency used, mode of telephone (analog or digital), coding method (TDMA or CDMA), network (GSM or iDEN), if the terminal has CDPD, GPRS and/or JAVA technology.

Furthermore the repository might contain information of different characteristics the terminal can handle with respect to applications, such as form factor or viewing area sizes, browser capabilities, languages supported, available input methods, text coverage, graphics support etc (display performance), expandability options and slots (peripherals and accessories), push technology support, ruggedness, information storage capability, adding new data to the devices (Memory), device performance calculations and logic (Processor speed) etc.

Furthermore, the repository might contain information regarding connectivity and functionality aspects depending on the network they belong to. These include gateways, towers and access links that are dependent on an organization's use of network protocols, application logic and device access. The characteristics for wireless networks are defined in terms of support to open Internet standards and protocols, extent of wireless networks coverage, cost factors, uniform/spotty coverage, data transmission speed, security concerns, time taken to service requests, authentication capabilities, etc.

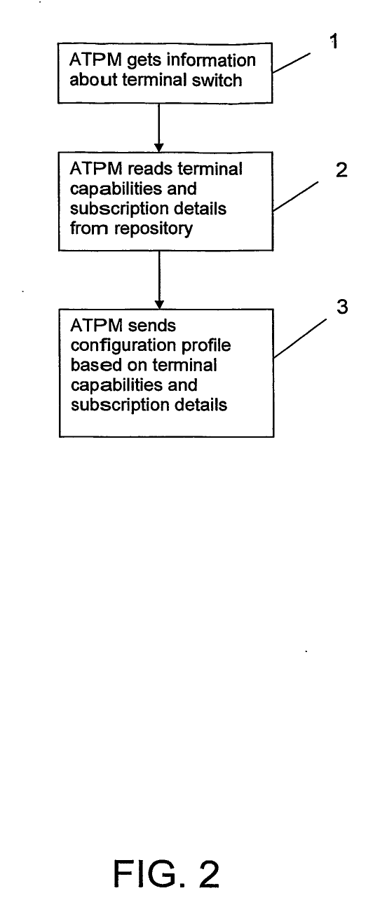

In FIG. 2, it is assumed that a terminal switch has taken place, i.e. a subscriber has got a new mobile terminal.

In step 1, information about the model of the new terminal together with information about the subscriber is then sent from a device detecting when a subscriber starts using a new terminal to the Adaptive Terminal Provisioning Manager, ATPM.

In step 2, ATPM, reads from the repository, which data shall be sent to the subscriber's new terminal, depending on terminal capabilities, subscription, and what programs the subscriber has had. For example if the new terminal has improved capabilities, a newer version of a program the subscriber has used, can be downloaded to the new terminal. This version is then better adapted to the properties of the new terminal, with respect to e.g. screen (size or colors instead of black and white), a new java version, etc. There are two types of data that can be downloaded. It can be data that the operator wants to download so that services would work well, such as the MMSC address for MMS, a data bearer for WAP (GPRS or CSD, Circuit Switched Data), a start page, book marks, an IP address, where data is sent (proxy) and for e-mail, authentication data (user-id, password) to proxy, a telephone number to the modem pool to set up data calls, modem protocols, an SMSC address. It can also be data that the user wants to have to get more functions, such as ring tones, games or WAP user-defined bookmarks.

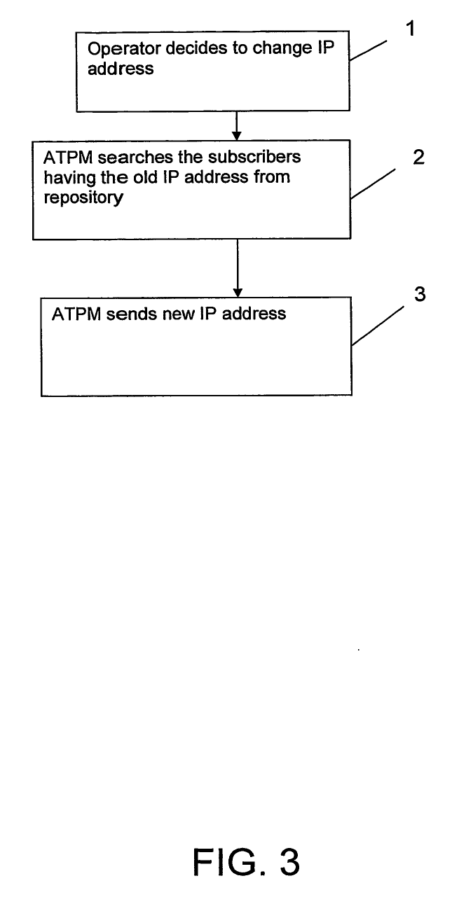

In this example ATPM sends configuration profile based on terminal capabilities (for example all details a certain modeneeds to work in the operator's network) and subscription details (e.g. the model's profile with CSD as bearer, plus the subscriber's old WAP bookmarks and Java programs) to the new terminal in step 3. In FIG. 3, it is assumed that the operator decides to update given information in one or more terminals. In this example, the operator decides to change the IP-address for a proxy, which has a certain value for that (proxy) parameter.

Thus, in step 1, the operator decides to change the IP-address and sends this information to ATPM. In step 2, ATPM searches the subscribers having the terminal installed on the old IP address. In step 3, ATPM sends the new IP address to the subscribers found in step 2.

Other things that the operator might want to download so that services would work properly is an MMSC address, an IP address to send data to, a new data bearer, telephone number to a modem pool to set up data calls, an SMSC address for MS, an IP address for e-mail.

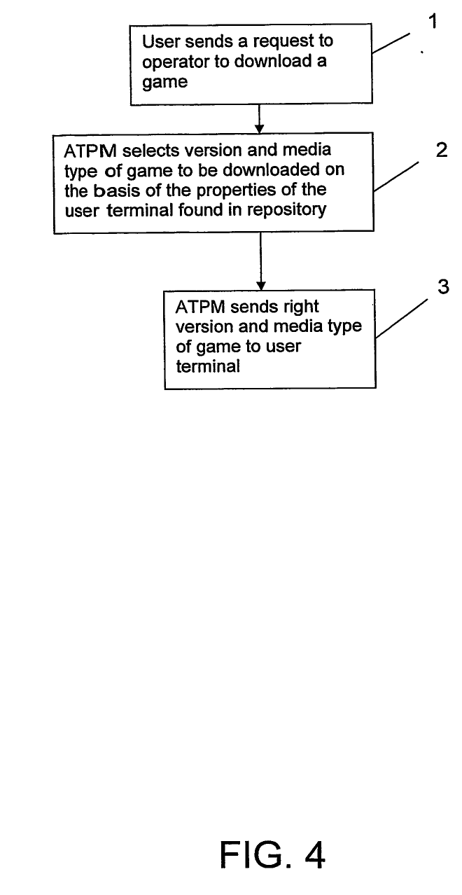

In FIG. 4, it is assumed that, a user wish to download a game to his mobile terminal.

In step 1 of FIG. 4, the user therefore sends a request to the operator to download a 66 game, i.e. this information comes from the subscriber via e.g. a web server to the operator and from there to ATPM. In step 2, ATPM selects version (with respect to e.g. screen type, java version) and media type) of game to be downloaded on the basis of the properties of the user's mobile terminal, which are found in the repository. Right version and type of game is then downloaded to the user terminal in step 3.

A user also might wish to have new ring tones or bookmarks.

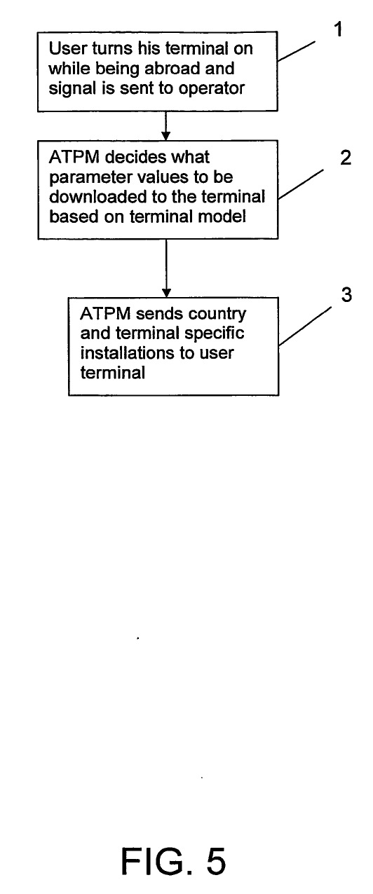

In FIG. 5, it is assumed that a user turns his terminal on while being abroad.

A signal about the new position is sent to the operator in step 1, when a user turns his terminal on while being abroad. This information comes from a roaming server of the operator. ATPM decides in step 2 what parameter values to be downloaded to the device/terminal based on the terminal model and the country the user is in. In step 3, the user terminal and country specific installations are sent to the user terminal.

1. A method for downloading data to mobile devices belonging to a mobile telecommunications network, comprising:
a) storing information of terminal capabilities and/or subscriber information of the mobile devices in the network,
b) initiating downloading of update information to one or more mobile devices,
c) forming a message with update information to be sent to said one or more mobile devices on the basis of said stored information, and
d) downloading the formed information message to said one or more mobile devices.

2. The method of claim 1, wherein the information of terminal capabilities includes standards, technologies, bandwidth constraints, mobile application characteristics, and/or network functionality.

3. The method of claim 2, wherein the network functionality information includes information about the download protocol used, gateways, towers and access links that are dependent on an organization's use of network protocols, application logic and device access, open Internet standards and protocols, extent of wireless networks coverage, cost factors, uniform/spotty coverage, data transmission speed, security concerns, time taken to service requests, and authentication capabilities.

4. The method of claim 2, wherein the application characteristics includes form factors, area sizes, browser capabilities, languages supported, available input methods, text coverage, graphics support expandability options and slots, push technology support, ruggedness, information storage capability, adding new data to the devices, device performance calculations and logic.

5. The method of claim 1, wherein the subscriber information includes information about which terminal a subscriber has, what data is downloaded on different devices, and information about subscription and what information a subscriber wants to have about new applications and updates.

6. The method of claim 1, wherein the address of the message to be downloaded is based on the location of the mobile device(s).

7. The method of claim 1, wherein downloading of update information is initiated by the operator on the basis of a specific parameter value to be downloaded.

8. The method of claim 1, wherein downloading of update information is initiated by the operator on the basis of a new version of software to be downloaded.

9. The method of claim 1, wherein downloading of update information is initiated by the user requesting data.

10. The method of claim 1, wherein downloading of update information is initiated by a terminal switch.

11. The method of claim 1, wherein downloading of update information is initiated by a new location of a terminal.

12. A network for downloading data to mobile devices, comprising; mobile devices and a mobile telecommunications network to which the mobile devices belong, and a repository containing information of terminal capabilities and/or subscriber information of the mobile devices in the network.

13. The network of claim 12, wherein the information of terminal capabilities includes standards, technologies, bandwidth constraints, mobile application characteristics, and/or network functionality.

14. The network of claim 13, wherein the network functionality information includes information about the download protocol used, gateways, towers and access links that are dependent on an organization's use of network protocols, application logic and device access, open Internet standards and protocols, extent of wireless networks coverage, cost factors, uniform/spotty coverage, data transmission speed, security concerns, time taken to service requests and authentication capabilities.

15. The network of claim 12, wherein the application characteristics includes form factors, area sizes, browser capabilities, languages supported, available input methods, text coverage, graphics support, expandability options and slots, push technology support, ruggedness, information storage capability, adding new data to the devices, device performance calculations and logic.

16. The network of claim 12, wherein the subscriber information includes information about which terminal a subscriber has, what data is downloaded on different devices, and information about subscription and what information a subscriber wants to have about new applications and updates.
